(19) United States
(12) Patent Application Publication
(10) Pub. No.: US 2024/0269781 A1
(43) Pub. Date: Aug. 15, 2024

(54) Ni-BASED AMORPHOUS BRAZING FOIL

(71) Applicant: Proterial, Ltd., Tokyo (JP)

(72) Inventor: Yoshio Bizen, Tokyo (JP)

(21) Appl. No.: 18/436,167

(22) Filed: Feb. 8, 2024

(30) Foreign Application Priority Data
Feb. 9, 2023 (JP) 2023-018756

(51) Int. Cl. B23K 35/30; B23K 35/02; C22C 19/05; C22C 45/00

(52) U.S. Cl. CPC B23K 35/304; B23K 35/0233; C22C 19/058; C22C 45/008; C22C 2200/02

(57) ABSTRACT

There is provided a Ni-based amorphous brazing foil containing: in mass %: Cr: from 19.0% to 30.0%; P: from 4.0% to 9.0%; Si: from 0.2% to 4.0%; B: from 0.3% to 1.0%; and a balance of Ni and impurities, in which B/Cr is 0.17 or less in terms of an atomic ratio.

### CROSS-REFERENCE TO RELATED APPLICATION

This application claims priority to Japanese Patent Application No. 2023-018756, filed on Feb. 9, 2023, the content of which is hereby incorporated by reference.

### TECHNICAL FIELD

The present disclosure relates to a Ni-based amorphous brazing foil.

### RELATED ART

In recent years, the market for water heaters with high energy saving and high efficiency has been expanding in Japan, as well as in Korea, Europe, and the United States. A Ni-based brazing filler metal is used for a heat exchanger composed of stainless steel in a water heater, and a Ni-based brazing filler metal having high corrosion resistance is required particularly in an area where hard water is largely distributed.

As a brazing filler metal exhibiting high corrosion resistance, BNi-15 standardized by AWS A5.8M/A5.8:2019 of the American Welding Society (AWS) and Specification for filler metals for brazing and braze welding is known. BNi-15 is a Ni-based alloy containing Cr, P, and Si, and has a specific composition (in mass %) of Cr: from 28.0 to 32.0%, B: 0.1% or less, Si: from 3.8 to 4.2%, P: from 5.5 to 6.5%, and Ni: a balance.

As a Ni-based brazing filler metal, a paste made by mixing a metal powder with a binder, and a foil are known.

Only a paste of BNi-15 is in practical use. Since the paste contains a binder, a binder removal process is required before brazing in a vacuum furnace or an atmosphere furnace. Since there is contamination of the lining and the exhaust system in the furnace due to the binder, it is required to remove the contamination periodically.

When the paste is used as described above, a binder-removing process with an extra cost in addition to the original brazing process is required. The coating thickness of the paste depends on the particle size of the metal powder contained. The particle size of the metal powder contained in the paste may exceed 100 μm, the coating thickness of the paste is as thick as about 100 μm, and the amount of the paste used is also large.

Since the foil is substantially a metal and does not contain a binder, a binder-removing process is not required, and there is almost no contamination in the furnace. Because the thickness of the foil is usually from 20 to 50 μm, the amount of the foil used can be reduced. The foil can be cut or punched according to the shape of a joint portion, and the assembly efficiency can be significantly improved as compared with the paste.

As the brazing foil, for example, Japanese Patent No. 6439795 discloses a Ni-based amorphous alloy ribbon for brazing having a composition represented by a composition formula: Ni_{100-d-x-y-z-f-g}Cr_{d}PₓSi_{y}B_{z}C_{f}N_{g} (22.00≤d≤29.00, 4.00≤x≤8.00, 1.00≤y≤7.00, 0.005≤z≤0.20, 0.005≤f≤0.100, 0.001≤g≤0.050, and 7.00≤x+y≤13.00 in % by mass).

### SUMMARY OF THE INVENTION

In consideration of assembly efficiency, a brazing foil exhibiting high corrosion resistance is desirable.

An object of the disclosure is to provide a Ni-based brazing foil with excellent ductility and corrosion resistance.

The above problems are solved by the following aspects.
<1> A Ni-based amorphous brazing foil comprising, in mass %:
Cr: from 19.0% to 30.0%;
P: from 4.0% to 9.0%;
Si: from 0.2% to 4.0%;
B: from 0.3% to 1.0%; and
a balance of Ni and impurities,
wherein B/Cr is 0.17 or less in terms of an atomic ratio.
<2> The Ni-based amorphous brazing foil according to <1>, wherein the Ni-based amorphous brazing foil has a width of from 5 mm to 300 mm and a thickness of from 10 μm to 100 μm.
<3> The Ni-based amorphous brazing foil according to <1> or <2>, further comprising Mo in an amount of 5.00 mass % or less.
<4> The Ni-based amorphous brazing foil according to any one of <1> to <3>, wherein a proportion of an amorphous phase is 50% or more.
<5> The Ni-based amorphous brazing foil according to any one of <1> to <4>, wherein a liquidus temperature is in a range of from 900° C. to 1,100° C.

According to the disclosure, there is a thin Ni-based amorphous brazing foil with excellent ductility and corrosion resistance.

### DETAILED DESCRIPTION OF THE INVENTION

An embodiment which is an example of a Ni-based amorphous brazing foil (hereinafter, may be simply referred to as a “brazing foil”) of the disclosure will be described. In the disclosure, a numerical range specified using “(from) . . . to . . . ” represents a range including the numerical values noted before and after “to” as the lower limit value and the upper limit value, respectively.

The content of an element of a chemical composition may be expressed by adding the “amount” to the element symbol (for example, the amount of Cr or the like). In addition, “%” means “mass %” concerning the content of each element.

In general, a Ni-based brazing foil is obtained in an amorphous state. As a method of producing a brazing foil, a rapid quenching method, where molten metal is quenched and solidified into a foil form, is known. This is a method in which molten metal is poured onto a rotating cooling roller and rapidly quenched and solidified on the cooling roller.

When an amorphous alloy is produced by a rapid quenching method, it is generally known to add boron (B) to enhance amorphous forming ability. However, the addition of Cr resulted in Cr₂B precipitates, enabling the formation of a Cr-depleted layer around the Cr₂B precipitate to deteriorate the corrosion resistance.

The inventors of the disclosure quantitatively evaluated the influence of an amount ratio of B to Cr on corrosion resistance. As a result, when a predetermined amount of each of Cr, P, Si, and B is contained in addition to Ni, and B/Cr is 0.17 or less in terms of an atomic ratio, it is determined that there is no problem in corrosion resistance, and the inventors have conceived a Ni-based amorphous brazing foil of the disclosure. A Ni-based amorphous brazing foil according to the disclosure contains, in mass %:
Cr: from 19.0% to 30.0%;
P: from 4.0% to 9.0%;
Si: from 0.2% to 4.0%;
B: from 0.3% to 1.0%; and
a balance of Ni and impurities,
in which B/Cr is 0.17 or less in terms of an atomic ratio.

Hereinafter, the chemical composition of the Ni-based amorphous brazing foil according to the disclosure will be described.

Chromium (Cr): from 19.0% to 30.0%

The Ni-based amorphous brazing foil according to the disclosure has an amount of Cr of from 19.0% to 30.0%. When the amount of Cr is less than 19.0%, corrosion resistance deteriorates. On the other hand, when the amount of Cr exceeds 30%, a casting nozzle is easily plugged during the production of the amorphous brazing foil, or the foil becomes brittle. From such a viewpoint, the amount of Cr is preferably 20.0% or more, and more preferably 23.0% or more. The amount of Cr is preferably 29.0% or less, and more preferably 28.5% or less.

Phosphorus (P): from 4.0% to 9.0%

The Ni-based amorphous brazing foil according to the disclosure has an amount of P of from 4.0% to 9.0%. When the amount of P is less than 4.0%, it is difficult to form a foil or a liquidus temperature increases. When the amount of P exceeds 9.0%, the liquidus temperature increases, or the brazing foil tends to be brittle. From such a viewpoint, the amount of P is preferably 5.0% or more, and more preferably 5.5% or more. The amount of P is preferably 8.5% or less, and more preferably 6.5% or less.

Silicon (Si): from 0.2% to 4.0%

The Ni-based amorphous brazing foil according to the disclosure has an amount of Si of from 0.2% to 4.0%. When the amount of Si is less than 0.2%, it is difficult to form a foil. When the amount of Si exceeds 4.0%, the foil tends to be brittle. From such a viewpoint, the amount of Si is preferably 0.5% or more, and more preferably 1.0% or more. The amount of Si is preferably 3.5% or less, and more preferably 3.0% or less.

Boron (B): from 0.3% to 1.0%

The Ni-based amorphous brazing foil according to the disclosure has an amount of B of from 0.3% to 1.0%. When the amount of B is less than 0.3%, it is difficult to form a foil. When the amount of B exceeds 1.0%, the liquidus temperature increases. From such a viewpoint, the amount of B is preferably 0.4% or more, and more preferably 0.5% or more. The amount of B is preferably 0.9% or less, and more preferably 0.8% or less.

B/Cr Atomic Ratio: 0.17 or less

The Ni-based amorphous brazing foil according to the disclosure has a B/Cr of 0.17 or less in terms of an atomic ratio (in the disclosure, it may be referred to as a “B/Cr atomic ratio”). When the contents of Cr and B are in the ranges described above and the B/Cr atomic ratio is 0.17 or less, a Cr-depleted layer is less likely to occur around Cr₂B precipitates and high corrosion resistance can be obtained. From the viewpoint of corrosion resistance, the B/Cr atomic ratio is preferably 0.15 or less, and more preferably 0.10 or less.

### Balance: Nickel (Ni) and Impurities

Examples of the impurities contained in the Ni-based amorphous brazing foil according to the disclosure include carbon (C), nitrogen (N), and iron (Fe). However, the impurity elements are not limited to these elements. The impurities mean elements unintentionally contained depending on raw materials supplied to produce the amorphous brazing foil.

The amount of impurities in mass % should be, an amount of C of 0.1% or less, an amount of N of 0.05% or less, and an amount of Fe of 1% or less. When the amount of C exceeds 0.1%, the amount of N exceeds 0.05%, and/or the amount of Fe exceeds 1%, there is a concern that carbides are formed by reacting with Cr in the brazing foil, and the corrosion resistance deteriorates.

Molybdenum (Mo): 5.00% or less

The Ni-based amorphous brazing foil according to the disclosure may contain Mo in an amount of 5.00% or less instead of a part of Ni. Mo is an additive element that has the effect of improving corrosion resistance. However, when the amount of Mo exceeds 5.00%, the liquidus temperature increases. When the Ni-based amorphous brazing foil according to the disclosure contains Mo, the amount of Mo is preferably 5.00% or less, and more preferably 3.0% or less. Since Mo is an optional element, a lower limit value is not limited. However, when Mo is contained, the amount of Mo is preferably 0.50% or more, and more preferably 1.00% or more, from the viewpoint of improving corrosion resistance.

The dimension of the Ni-based amorphous brazing foil according to the disclosure is not particularly limited, and the width of the Ni-based amorphous brazing foil is preferably from 5 mm to 300 mm to produce a brazing foil steadily.

The thickness of the Ni-based amorphous brazing foil according to the disclosure is not particularly limited, and the thickness is preferably from 10 μm to 100 μm from the viewpoint of improving ductility of amorphous brazing foil.

The Ni-based amorphous brazing foil according to the disclosure contains an amorphous phase, and the amorphous phase may be 100%, but a crystalline phase may be partially formed. From the viewpoint of improving the ductility of the amorphous brazing foil, a proportion of the amorphous phase in the Ni-based amorphous brazing foil according to the disclosure is preferably 50% or more.

A proportion of the amorphous phase X can be determined from an integrated scattering intensity of X-ray diffraction by the following formula.

$$X = Ia / ( Ic + Ia ) \times 100$$

Ic: Crystalline integrated scattering intensity
Ia: Amorphous integrated scattering intensity

The Ni-based amorphous brazing foil according to the disclosure preferably has a liquidus temperature of from 900° C. to 1,100° C. When the liquidus temperature of the brazing foil is in the above temperature range, the brazing temperature can be set in a range of from 950 to 1,150° C. In this case, deterioration of corrosion resistance due to the sensitization of stainless steel as base metals to be joined and reduction in mechanical strength due to the coarsening of crystal grains is suppressed. Moreover, a stainless steel brazed joint having both high corrosion resistance and high joining strength is obtained.

Next, an example of a method of producing a Ni-based amorphous brazing foil according to the disclosure will be described.

The Ni-based amorphous brazing foil according to the disclosure can be produced by a conventionally well-known rapid quenching method such as a single roller method. Specifically, the molten alloy within the composition range of the disclosure described above is held at a temperature of, for example, 1,200° C. or higher, and is ejected from the casting nozzle to the surface of a copper alloy roller rotating at a high speed. In this case, the molten alloy having the composition described above is ejected from a slit formed at the tip of the casting nozzle, is poured onto the surface of the roller, is instantaneously quenched, and solidified in an amorphous state to form a long amorphous alloy ribbon.

Since the copper alloy roller is internally water-cooled, the surface temperature of the roller can be suitably controlled. As a material of the roller, a Cu—Be alloy, a Cu—Cr alloy, a Cu—Zr alloy, a Cu—Cr—Zr alloy, a Cu—Ni—Si alloy, or the like is used. The rotating speed of the roller is generally set in a range of from 15 m/s to 35 m/s. A gap between the surface of the roller and the tip of the casting nozzle is generally set in a range of from 50 μm to 250 μm.

When the molten alloy described above is ejected from the slit of the casting nozzle, the tip of the casting nozzle and/or the surface of the roller may be in a protective gas atmosphere such as argon gas, helium gas, carbon dioxide gas, a vacuum, etc. For example, when at least the tip of the casting nozzle is in a protective gas atmosphere or a vacuum, it is possible to suppress oxidation of the molten alloy and prevent plugging of the casting nozzle. This is preferable because the amount of oxygen included in the ribbon can be reduced to improve the joining strength of the brazed joint. To suppress the plugging of the casting nozzle, it is preferable to heat the tip of the casting nozzle to a suitable temperature.

The ribbon can have dimensions of a thickness of 10 μm to 100 μm and a width of 5 mm to 300 mm. The dimensions of the ribbon can vary under the influence of various conditions such as the composition and temperature of the molten alloy, the dimensions of the slit of the casting nozzle, the gap between the tip of the casting nozzle and the surface of the roller, the rotating speed, the surface temperature, and the surface roughness of the roller.

The preforms of Ni-based amorphous brazing foil according to the disclosure may be produced by, for example, cutting, punching, or bending the foil obtained as described above, if necessary.

### EXAMPLES

Hereinafter, examples will be described, and the Ni-based amorphous brazing foil according to the disclosure is not limited to the following examples.

### <Production of Ni-Based Amorphous Brazing Foil>

A Ni-based amorphous brazing foil according to an embodiment of the disclosure was prepared using a single roller apparatus which is one of the rapid quenching methods. Specifically, first, a raw material blended to have a predetermined composition was inductively melted to prepare a master alloy, and the master alloy was heated to 1,200° C. and melted in a crucible just above a casting nozzle. Second, the molten metal was ejected from a slit provided at the tip of the casting nozzle to a surface of a cooling roller with a Cu—Be alloy and quenched and solidified. A gap between the tip of the casting nozzle and the surface of the cooling roller was set to 100 μm, and the rotating speed of the cooling roller was set to 30 m/s.

As a result, Ni-based brazing foil having compositions (% by mass) of Nos. 1 to 9 shown in Table 1 and having a width of 10 mm and a thickness of 25 μm were prepared. In the samples of Nos. 1, 2, 5, 6, 8, and 9, Mo is not added and indicates a value contained as an impurity.

### <Evaluation>

### (Crystal Structure Analysis)

Next, to confirm whether the formed phase of the prepared foil was in an amorphous state, a test piece (10 mm in width, 20 mm in length) was taken from the foil and analyzed with an X-ray diffractometer.

As a result of analyzing each test piece, an amorphous state was confirmed, and the proportion of the amorphous phase was 50% or more. In Table 1, the formed phase is described as AM.

### (Evaluation of Ductility)

To confirm the ductility of the foil, a test piece (10 mm in width, 20 mm in length) taken from the foil was folded at an intermediate portion in a length direction between two plates and tightened with a micrometer. When the test piece was not cracked even after being fully in close contact with each other, the ductility was evaluated as “A”, and when the test piece was cracked halfway, the ductility was evaluated as “C”. At this time, it was determined that the ductility was excellent when the test pieces were fully in close contact with each other without cracking, and it was determined that the ductility was not excellent when the test pieces were cracked halfway.

### (Liquidus Temperature Measurement)

A liquidus temperature TL was measured by differential thermal analysis using a test piece taken from the foil.

The respective measurement results are shown in Table 1.

### (Brazing Test)

As a base material, austenitic stainless steel SUS304 was selected.

Brazing foil having different B/Cr atomic ratios (a joint surface was 1 mm×5 mm and a foil was 25 μm×1 mm×5 mm) was preplaced between the stainless steels (1 mm in thickness, 5 mm in width, 10 mm in length) and brazed at 1,080° C. for 0.1 minutes in vacuum.

A cross-section of the brazed joined was observed with an optical microscope (magnification ×50) to confirm the presence or absence of non-joined portions at the cross-section of the brazed joined. There were no non-joined portions in any samples, and the joining was evaluated as “A” (Table 1).

### (Corrosion Resistance Test)

The brazed joint was immersed in a sulfuric acid H₂SO₄ solution having a concentration of 10 mass % (a liquid temperature was 60° C.) for 3 hours, and the corrosion state in the vicinity of the joint interface between the stainless steel and the brazing foil was observed with a 3D laser microscope (Keyence VR-3200). A maximum corrosion depth was measured, and when a maximum corrosion depth was 0.015 mm or less, it was evaluated as “A” (excellent corrosion resistance), and when a maximum corrosion depth exceeded 0.015 mm, it was evaluated as “C” (poor corrosion resistance). The value of the maximum corrosion depth is preferably as small as possible, and is preferably 0.013 mm or less, more preferably 0.010 mm or less, and still more preferably 0.009 mm or less.

The results of these tests are shown in Table 1. In Table 1, the underlined chemical composition means that it is outside the scope of the disclosure. The “balance” of Ni also includes impurities.

TABLE 1

| | | | | | | | | Evaluation | | | | | |
|---|---|---|---|---|---|---|---|---|---|---|---|---|---|
| | Chemical composition | | | | | | | | | | | Maximum | |
| | (% by mass other than | | | | | | B/Cr | | | | | corrosion | |
| | “B/Cr atomic ratio”) | | | | | | atomic | Formed | | T_{L} | | depth | Corrosion |
| No. | NI | Cr | P | Si | B | Mo | ratio | phase | Ductility | (° C.) | Joining | (mm) | resistance |
| 1 | Balance | 28.1 | 6.2 | 2.7 | 0.5 | 0.05 | 0.08 | AM | A | 965 | A | 0.008 | A |
| 2 | Balance | 27.5 | 6.4 | 1.4 | 0.4 | 0.11 | 0.08 | AM | A | 969 | A | 0.007 | A |
| 3 | Balance | 24.1 | 5.9 | 1.4 | 0.5 | 1.42 | 0.09 | AM | A | 955 | A | 0.009 | A |
| 4 | Balance | 20.8 | 8.1 | 0.5 | 0.5 | 1.10 | 0.10 | AM | A | 940 | A | 0.010 | A |
| 5 | Balance | 25.0 | 6.2 | 3.1 | 0.9 | 0.01 | 0.17 | AM | A | 995 | A | 0.013 | A |
| 6 | Balance | 29.1 | 5.7 | 4.0 | 1.2 | 0.01 | 0.19 | AM | C | 1025 | A | 0.028 | C |
| 7 | Balance | 22.7 | 6.1 | 1.5 | 1.9 | 0.82 | 0.41 | AM | A | 877 | A | 0.030 | C |
| 8 | Balance | 6.9 | 0.0 | 4.5 | 1.6 | 0.10 | 1.08 | AM | A | 1020 | A | 0.027 | C |
| 9 | Balance | 6.7 | 0.0 | 4.5 | 3.1 | 0.01 | 2.24 | AM | A | 1015 | A | 0.139 | C |

It can be confirmed that the brazing foil in which the amount of each element is within the range of the disclosure and the B/Cr atomic ratio is 0.17 or less has excellent ductility and corrosion resistance.

The disclosure of Japanese Patent Application No. 2023-018756, filed on Feb. 9, 2023, is incorporated into the present specification by reference in its entirety. All documents, patent applications, and technical standards described in the present specification are incorporated into the present specification by reference to the same extent as if the individual documents, patent applications, and technical standards were specifically and individually described.

What is claimed is:

1. A Ni-based amorphous brazing foil comprising, in mass %:
Cr: from 19.0% to 30.0%;
P: from 4.0% to 9.0%;
Si: from 0.2% to 4.0%;
B: from 0.3% to 1.0%; and
a balance of Ni and impurities,
wherein B/Cr is 0.17 or less in terms of an atomic ratio.

2. The Ni-based amorphous brazing foil according to claim 1, wherein the Ni-based amorphous brazing foil has a width of from 5 mm to 300 mm and a thickness of from 10 μm to 100 μm.

3. The Ni-based amorphous brazing foil according to claim 1, further comprising Mo in an amount of 5.00 mass % or less.

4. The Ni-based amorphous brazing foil according to claim 1, wherein a proportion of an amorphous phase is 50% or more.

5. The Ni-based amorphous brazing foil according to claim 1, wherein a liquidus temperature is in a range of from 900° C. to 1,100° C.
